(19) United States
(12) Patent Application Publication
(10) Pub. No.: US 2020/0355363 A1
(43) Pub. Date: Nov. 12, 2020

(54) LIGHT SOURCE WITH KEY TO AUDIO FILE

(71) Applicants: Ambigai Susheila Sithamparanathan, Los Angeles, CA (US); Jon Hammond Hagan, Woodland Hills, CA (US)

(72) Inventors: Ambigai Susheila Sithamparanathan, Los Angeles, CA (US); Jon Hammond Hagan, Woodland Hills, CA (US)

(21) Appl. No.: 16/869,308

(22) Filed: May 7, 2020

Related U.S. Application Data
(60) Provisional application No. 62/844,308, filed on May 7, 2019.

(51) Int. Cl. F21V 33/00; G06F 3/16; F21V 35/00; F21V 23/00; G06F 21/62

(52) U.S. Cl. CPC F21V 33/0056; G06F 3/16; G06F 21/6209; F21V 23/003; F21V 35/00

(57) ABSTRACT

Some embodiments are of systems and/or methods for facilitating and/or providing guided meditation that may include at least one light source (e.g., a candle), a key (e.g., a QR code or a RFID/NFC tag) with access-information, at least one server, and one or more audio files on that least one server. The access-information may be for accessing and/or using the one or more audio files. The key is provided with the light source. The key may facilitate access to the one or more audio files. During a given guided meditation session, the light source and the one or more audio files may be used together, provided that the key was used to grant access to the one or more audio files. The one or more audio files may be played from a user-computing-device, such as, but not limited to, a smartphone, a smart speaker, or a tablet computing device.

### PRIORITY NOTICE

The present application claims priority under 35 U.S.C. § 119(e) to U.S. Provisional Patent Application Ser. No. 62/844,308 filed on May 7, 2019, the disclosure of which is incorporated herein by reference in its entirety.

### TECHNICAL FIELD OF THE INVENTION

The present invention relates in general to candles and soundbaths and more specifically to means for combining specific candle use with specific soundbaths.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Currently (circa 2019) candles may be and have been used for various therapeutic, cleansing, focusing, relaxation, and/or meditative purposes. Further, candles may be themed for such particular purposes, such as, being made to emit specific and predetermined scents and/or fragrances, to burn for specific periods of time, to burn with predetermined levels of intensity, and/or the like.

Similarly, various sounds and/or music may be and have been used for various purposes, such as, therapeutic, cleansing, focusing, relaxation, and/or meditative purposes. Such sounds and/or music may be known as soundbaths and may be themed, organized, and/or curated for such particular purposes. Such sounds and/or music may also include various instructions (e.g., a person speaking instructions and/or a recording of a person speaking instructions) for guided meditation purposes.

However, specifically themed candles are not provided with specifically themed and/or curated soundbaths. It would be desirable to provide specifically themed candles with specifically themed and/or curated soundbaths, such that the user may then experience a unique guided and/or curated soundbath meditation experience whilst simultaneously enjoying/using/benefiting from the lighting of a particular themed candle.

There is a need in the art for specifically themed candles that are linked and/or paired with specifically themed and/or curated soundbaths.

It is to these ends that the present invention has been developed.

### BRIEF SUMMARY OF THE INVENTION

To minimize the limitations in the prior art, and to minimize other limitations that will be apparent upon reading and understanding the present specification, embodiments of the present invention may describe systems and/or methods for facilitating and/or providing guided meditation that may comprise at least one light source (e.g., a candle), at least one key (e.g., a QR code or a RFID/NFC tag) with access-information, at least one server, and one or more audio files non-transitorily stored on that at least one server (or otherwise available from that at least one server), wherein the access-information may be for accessing and/or using the one or more audio files during a given meditation session. In some embodiments, the key may be provided with the light source. For example, and without limiting the scope of the present invention, the key may be on the light source, in the light source, partially in the light source, on the packaging of the light source, in the packaging of the light source, partially in the packaging of the light source, not attached to light source, not attached to the packaging of the light source, combinations thereof, and/or the like. The key may provide access to the one or more audio files. During a given guided meditation session, the light source and the one or more audio files may be used together, provided that the key was used to grant access to the one or more audio files. The one or more audio files may be played from a user-computing-device, such as, but not limited to, a smartphone, a tablet computing device, a laptop, a smart speaker, a desktop computer, a smart watch, combinations thereof, and/or the like. The one or more audio files may comprise one or more of: sounds, music, instructions (e.g., verbal instructions), any one of which may be predetermined, combinations thereof, and/or the like.

It is an objective of the present invention to provide an immersive sound candle.

It is another objective of the present invention to provide a light source (e.g., a candle) along with a key, wherein they key contains access-information for accessing one or more audio files intended to be listened to while using the light source.

It is yet another objective of the present invention to provide a specifically themed light source (e.g., a candle) along with a key, wherein they key contains access-information for accessing specifically themed one or more audio files (e.g., as a specifically themed soundbath [soundbath]) intended to be listened to while using the specifically themed light source.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 may depict a schematic block diagram showing relationships between a light source and a key; and/or showing relationships between packaging of the light source and the key(s).

FIG. 2 may depict a schematic block diagram showing how one or more audio files residing in a server may be accessed by a user-computing-device that has received access-information from a key. FIG. 2 may also depict how the one or more audio files may be broadcast (after access has been verified) and wherein such broadcast of the one or more audio files may occur while the light source is activated.

FIG. 3 a schematic block diagram of at least some hardware componentry of a computer, wherein such a computer may be the user-computing-device or the server.

FIG. 4 may depict some steps in a method of providing guided meditation.

### REFERENCE NUMERAL SCHEDULE

100 light source 100
101 key 101
103 key 103
105 key 105
107 key 107
109 packaging 109
201 user-computing-device 201
203 server 203
205 Internet/WAN/LAN 205
207 audio-output 207
301 processor 301
303 memory 303
305 scanner 305
307 network communication module 307
309 Inputs/Outputs 309
311 power source 311
400 method of providing guided meditation 400
401 pairing light source with key of access-information 401
403 receiving access-information from a key at a user-computing-device 403
405 transmitting the access-information from the user-computing-device to a server 405
407 receiving the access-information at the server 407
409 receiving request to access one or more audio files 409
411 verifying the access-information 411
413 providing the one or more audio files 413
415 blocking access of the one or more audio files 415
417 activating a light source and broadcasting the one or more audio files 417

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

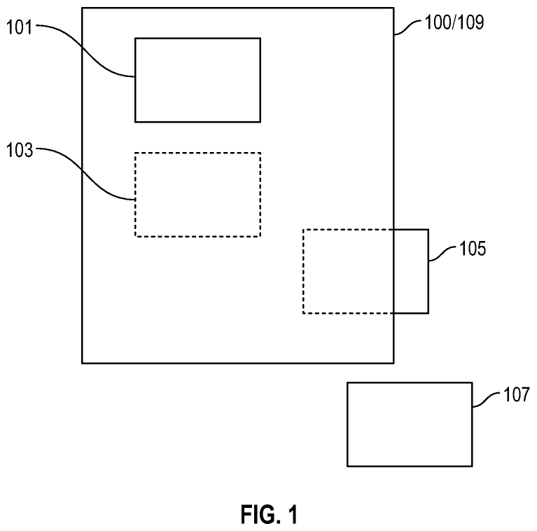

FIG. 1 may depict a schematic block diagram showing relationships between a light source 100 and a key 101/103/105/107; and/or showing relationships between packaging 109 of the light source 100 and the key 101/103/105/107. Note language use of “key 101/103/105/107” may be referring to key 101, key 103, key 105, and/or key 107. And “100/109” in FIG. 1 may be referring to light source 100 and/or to packaging 109.

In some embodiments, light source 100 may be portable, mobile, handheld, sized to be handheld, combinations thereof, and/or the like. In some embodiments, light source 100 may be self-powered (e.g., when light source 100 may be a candle or battery operated LED device). In some embodiments, light source 100 may be of a specific and predetermined theme. In some embodiments, this specific and predetermined theme may comprise one or more of specific predetermined: scents and/or fragrances, light intensity, lighting time, lighting color, light wavelength(s), combinations thereof, and/or the like. In some embodiments, this specific and predetermined theme may be paired/linked with a specific predetermined sound-bath (provided by one or more specific predetermined audio files). In some embodiments, light source 100 may be one or more of: a candle and/or an electrically powered light source. In some embodiments, the electrically powered light source may be one or more of: a LED (light emitting diode), an incandescent light, a fluorescent light source, a neon light source, other light emitting electrically powered device, combinations thereof, and/or the like. In some embodiments, light source 100 may be scented. In some embodiments, when light source 100 may be active, i.e., actively emitting light, light source 100 may also emit various predetermined scents and/or fragrances. In some embodiments, light source 100 may be used in one or more of: light therapy, meditation, guided meditation, relaxation, aroma therapy, used in conjunction with specific predetermined sounds (e.g., a soundbath), combinations thereof, and/or the like.

In some embodiments, candles (e.g., as a type of light source 100) may be substantially constructed of one or more waxes and/or wax like materials, such as, but not limited to plant based waxes, beeswax, paraffin wax, combinations thereof, and/or the like. In some embodiments, candles (e.g., a type of light source 100) may also include one or more scents and/or fragrances. Candles of such characteristics are well known in the relevant arts.

Note with respect to the materials of construction, it is not desired nor intended to thereby unnecessarily limit the present invention by reason of such disclosure.

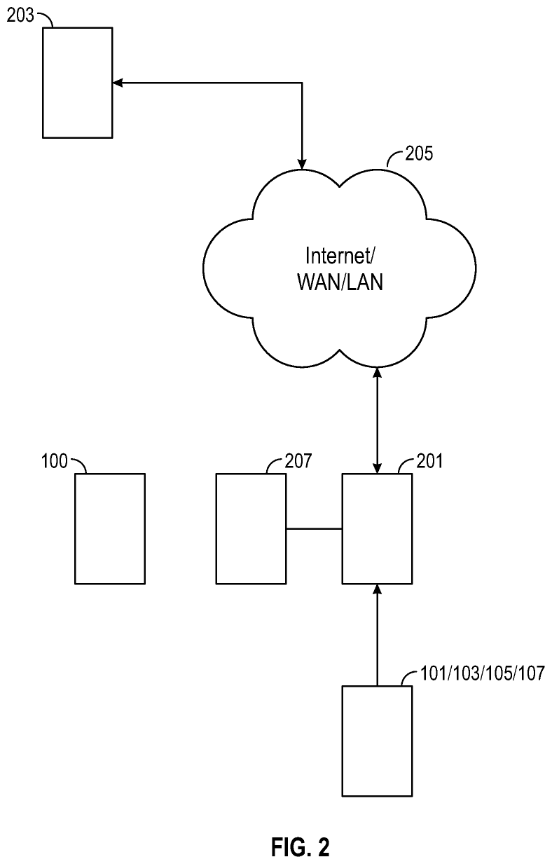

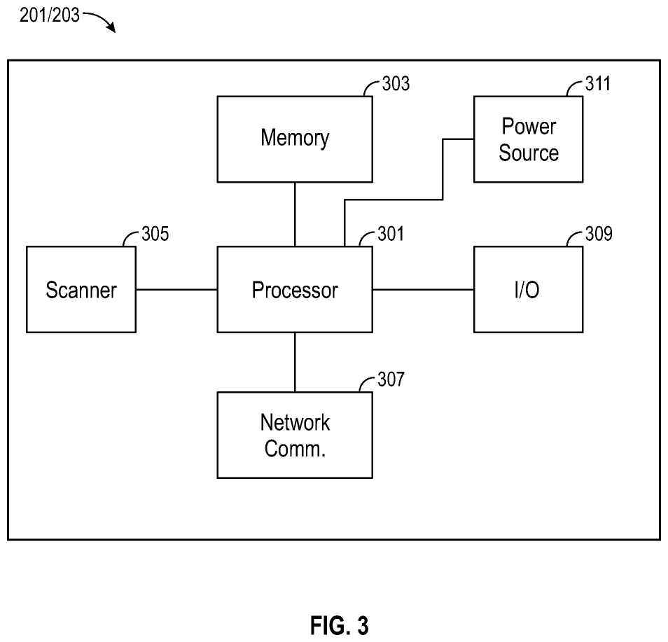

In some embodiments, keys 101, 103, 105, and/or 107 may contain information, “access-information,” for accessing one or more audio files. In some embodiments, keys 101, 103, 105, and/or 107 may comprise one or more of: a bar code, a QR code (quick response code), a 2D code (two dimensional code), a 3D code (three dimensional code), a RFID tag (radio frequency ID tag), a NFC tag (near field communication tag), combinations thereof, and/or the like. In some embodiments, the bar codes, the QR codes, the 2D codes, the 3D codes, the RFID tags, and/or the NFC tags may have information and/or instructions (e.g., the access-information) for accessing the one or more audio files. In some embodiments, the one or more audio files may be audio files for meditation, soundbaths, guided meditation, instructions (e.g., verbal instructions), sounds, predetermined sounds, music, predetermined music, combinations thereof, and/or the like. In some embodiments, the one or more audio files may be non-transitorily stored within memory 303 of a given server 203 (e.g., within a database of server 203) (see FIG. 3 for memory 303 and see FIG. 2 for server 203). In some embodiments, the access-information of the bar codes, the QR codes, the 2D codes, the 3D codes, the RFID tags, and/or the NFC tags may be paired (e.g., in a database lookup table or the like) with the one or more audio files.

Continuing discussing FIG. 1, in some embodiments, key 101 may be located on an exterior surface of light source 100. For example, and without limiting the scope of the present invention, key 101 may be located on a top, on a bottom, on a side, and/or combinations thereof of light source 100. In some embodiments, key 103 may be located within light source 100. In some embodiments, key 103 may be embedded within light source 100. In some embodiments, key 103 may be visible from an exterior of light source 100 (e.g., because the exterior of light source 100 may be substantially visually transparent/translucent). In some embodiments, key 105 may be located partially within light source 100 and partially outside of light source 100. In some embodiments, key 101, key 103, and/or key 105 may be attached to light source 100. In some embodiments, key 107 may be unattached from light source 100. The broken lines (dotted lines) in FIG. 1 may indicate that the given key (e.g., key 103 and/or key 105) has at least some portions within the given light source 100; and/or at least some portions within the given packaging 109.

Continuing discussing FIG. 1, in some embodiments, packaging 109 may be the packaging for light source 100. In some embodiments, prior to unwrapping light source 100 from packaging 109, light source 100 may be at least partially located within packaging 109. For example, and without limiting the scope of the present invention, packaging 109 may be a box, a bag, shrink wrap, plastic covering, covering, combinations thereof, and/or the like. In some embodiments, key 101 may be located on an exterior surface of packaging 109. For example, and without limiting the scope of the present invention, key 101 may be located on a top, on a bottom, on a side, and/or combinations thereof of packaging 109. In some embodiments, key 103 may be located within packaging 109. In some embodiments, key 103 may be embedded within packaging 109. In some embodiments, key 103 may be visible from an exterior of packaging 109 (e.g., because the exterior of packaging 109 may be substantially visually transparent/translucent). In some embodiments, key 105 may be located partially within packaging 109 and partially outside of packaging 109. In some embodiments, key 101, key 103, and/or key 105 may be attached to packaging 109. In some embodiments, key 107 may be unattached from packaging 109. In some embodiments, key 107 may be unattached from packaging 109 and from light source 100.

In some embodiments, in a planned stream of commerce scenario, a given key 101, 103, 105, or 107 may be provided with a given light source 100 (e.g., packaged and sold together to the user), with an intent that when that given light source 100 may be activated for a purpose such as meditation (e.g., guided meditation), that the provided key 101, 103, 105, or 107, may allow the user to access the one or more audio files, such that the one or more audio files may be broadcast to and audibly heard by the user during that given meditation session while simultaneously using that light source 100. In some embodiments, the one or more audio files may include instructions (e.g., verbal instructions) for a guided meditation session(s).

FIG. 2 may depict a schematic block diagram showing how one or more audio files residing in server 203 may be accessed by a user-computing-device 201 that has received access-information from key 101/103/105/107. FIG. 2 may also depict how the one or more audio files may be broadcast/streamed (after access has been verified) and wherein such broadcast/streaming of the one or more audio files may occur while the light source 100 is activated, such that broadcasting/streaming of the one or more audio files may compliment light emission from light source 100.

In some embodiments, user-computing-device 201 may be a computer. In some embodiments, user-computing-device 201 may be selected from: a mobile computing device, a smartphone, a tablet computing device, a smart speaker, a smart watch device, a wearable computing device, a laptop computer, a tower computer, a desktop computer, a workstation computer, combinations thereof, and/or the like.

In some embodiments, server 203 may be one or more servers, wherein each such server may be a computer.

Continuing discussing FIG. 2, in some embodiments, user-computing-device 201 may scan, read, interrogate, communicate with, combinations thereof, and/or the like with respect to key 101, key 103, key 105, and/or key 107 in order for user-computing-device 201 to receive the access-information from the given key 101, key 103, key 105, and/or key 107. In some embodiments, user-computing-device 201 may use its scanner 305 to accomplish such scanning, reading, interrogating, and/or communicating functions (see FIG. 3 for scanner 305). In some embodiments, scanner 305 may be a camera and/or an antenna. In some embodiments, when key 101/103/105/107 may comprise bar codes, QR codes, 2D codes, and/or 3D codes, and wherein scanner 305 may be a camera. In some embodiments, when key 101/103/105/107 may comprise RFID tags and/or NFC tags, scanner 305 may be at least one antenna(s) of the given user-computing-device 201.

Continuing discussing FIG. 2, in some embodiments, after user-computing-device 201 has received the access-information from scanning, reading, interrogating, and/or communicating key 101/103/105/107, user-computing-device 201 may then cause transmission of that access-information to at least one server 203. In some embodiments, communications between user-computing-device 201 and the at least one server 203 may be routed, at least partially, through Internet/WAN/LAN 205. In some embodiments, such communications between user-computing-device 201 and the at least one server 203 may include user-computing-device 201 transmitting the access-information to the at least one server 203; and/or may include the at least one server 203 providing the more or more audio files for use by user-computing-device 201 (e.g., if the at least one server 203 verifies/validates authenticity of access-information received from the given user-computing-device 201).

In some embodiments, communications between user-computing-device 201 and at least one server 203, via at least portions of Internet/WAN/LAN 205, may be via one or more preexisting communications protocols, industry accepted communications protocols, combinations thereof, and/or the like; wherein such communications protocols are well understood and characterized by the relevant arts.

Continuing discussing FIG. 2, in some embodiments, after the at least one server 203 has received the access-information from user-computing-device 201, the access-information may be verified/validated; and if verified, the more or more audio files that may be paired (linked) with this given access-information and may then be available for use by this particular user-computing-device 201. In some embodiments, this may further entail user-computing-device 201 providing its “unique identifying characteristics,” along with the access-information, to the at least one server 203, so that the paired (linked) one or more audio files may be provided for use by this particular user-computing-device 201. In some embodiments, the unique identifying characteristics of user-computing-device 201 may include (comprise) one or more of: model number, serial number, media address (MAC address), IP address, combinations thereof, and/or the like with respect to that particular user-computing-device 201.

In some embodiments, Internet/WAN/LAN 205 may include (comprise) portions of the Internet, portions of a wide area network (WAN), portions of a local area network (LAN), combinations thereof, and/or the like. In some embodiments, Internet/WAN/LAN 205 may include (comprise) networking hardware, such as, but not limited to, cabling, wireless communication hardware (e.g., radios and/or antennas), routers, modems, switches, hubs, gateways, servers, storage, combinations thereof, and/or the like. Componentry of Internet/WAN/LAN 205 is well understood in the relevant arts.

Continuing discussing FIG. 2, in some embodiments, when the user desires use of light source 100 and/or use of the one more audio files (e.g., the user desires to conduct a given meditation session [such as, but not limited to, guided meditation]), the user, via user-computing-device 201, may submit a request to access/use the one or more audio files. In some embodiments, this request to access/use the one or more audio files may be received at the at least one server 203. In some embodiments, if the access-information was successfully verified/validated, then upon the at least one server 203 receiving the request access/use the one or more audio files, then the at least one server 203 may provide the one or more audio files for use by the user-computing-device 201. In some embodiments, this providing of the one or more audio files from the at least one server 203 to the particular user-computing-device 201, may be in the form of “streaming,” such that the one or more audio files themselves are not transferred from the at least one server 203 to the particular user-computing-device 201, but rather only the content of the one or more audio files may be provided (e.g., played and/or broadcast). Whereas, in other embodiments, this providing of the one or more audio files from the at least one server 203 to the particular user-computing-device 201, may be in the form of transferring copies (temporary copies in some embodiments) of the one or more audio files themselves from the at least one server 203 to the particular user-computing-device 201, i.e., not streamed. In either scenario (streamed or actual file transfer), there may be limitations that stop access/use of the one or more audio files after some triggering event. In some embodiments, this triggering event, may be a predetermined amount of elapsed time (e.g., 30 days and/or other time periods) from when the scanner 305 of the given user-computing-device 201 scanned, read, interrogated, and/or communicated the access-information from the given key 101/103/105/107. In some embodiments, this triggering event, may be a predetermined amount of streams or a predetermined amount of plays from transferred one or more audio files. In some embodiments, once this triggering event has occurred, user-computing-device 201 may be barred from using and/or accessing the one or more audio files.

Continuing discussing FIG. 2, in some embodiments, when user-computing-device 201 may be broadcasting, using, and/or playing the one or more audio files, the one or more audio files may be heard from audio-output 207. In some embodiments, audio-output 207 may be one or more speakers of user-computing-device 201 (e.g., integral speakers of user-computing-device 201). In some embodiments, audio-output 207 may be one or more headphones and/or speakers in communication (e.g., wired or wireless communication) with user-computing-device 201.

FIG. 3 a schematic block diagram of at least some hardware componentry of a computer, wherein such a computer may the user-computing-device 201 or the at least one server 203. The language of “201/203” in FIG. 3 may mean the shown computer block diagram may be applied to either user-computing-device 201 or the at least one server 203. In some embodiments, the schematic computer shown in FIG. 3 may comprise: processor 301 (e.g., at least one processor 301), memory 303, scanner 305, network communications module 307, Inputs/Outputs 309, power source 311, circuits, buses, combinations thereof, and/or the like.

FIG. 3 may depict a block diagram showing some sub-hardware elements (e.g., some circuitry components) for a computer, such as, user-computing-device 201 and the at least one server 203. In some embodiments, such a computer may be selected from one or more of: a smartphone, a tablet computing device, a smart speaker, a smart watch, a wearable computer, a laptop computer, a desktop computer, a tower computer, a server computer (server), a work-station computer (workstation), and/or the like.

Continuing discussing FIG. 3, in some embodiments, this computer (user-computing-device 201 or the at least one server 203) may comprise one or more circuits. In some embodiments, this computer may comprise a printed circuit board (PCB) or may comprise one or more such PCBs. In some embodiments, this computer may comprise one or more of the following sub-hardware elements (components): processor(s) 301, one or more memory 303, scanner 305, one or more network communications module 307, Inputs/Outputs (I/O) 309, and power-supply 311. “I/O” herein may refer to “inputs/outputs” as is commonly known in the computing and electronics industries. In some embodiments, the one or more processors 301 may be electrically and/or optically coupled (e.g., via wiring, cabling, bus, and/or the like) with the one or more memory 303, scanner 305, one or more network communications module 307, I/O 309, power-supply 311, combinations thereof, and/or the like. In some embodiments, at least some of processors 301, one or more memory 303, scanner 305, one or more network communications module 307, I/O 309, and/or power-supply 311 may be operationally linked/connected with one another, such as via electrical/optical wired connections.

In FIG. 3, in some embodiments, processor 301 may be one or more processors, including one or more central processors and/or one or more processors for graphics. In some embodiments, processor 301 may be in communication with memory 303. In some embodiments, processor 301 may be in communication with scanner 305. In some embodiments, processor 301 may be in communication with network communications module 307. In some embodiments, processor 301 may be in communication with I/O 309. In some embodiments, processor 301 may be in communication with power-supply 311. In some embodiments, such communications of/with processor 301 may be facilitated via wired connections for electrical (and/or optical) communications. In some embodiments, processor 301 may receive electrical power necessary for operations from power-supply 311.

In FIG. 3, in some embodiments, scanner 305 may be one or more of camera(s); antennas for RFID/NFC communications; and/or the like.

In FIG. 3, in some embodiments, the inputs of I/O 309 may be one or more inputs selected from inputs from: a keypad; a touchscreen; buttons; switches; a keyboard; a stylus; a mouse; a trackball; a touchpad; a lever; a slide; dials; camera(s); RFID/NFC reader/receiver/scanner; hardwired electrical power ports (e.g., a USB port or the like); hardwired data ports (e.g., a USB port or the like); incoming communications received via network communications module 307; microphones; and/or the like. In some embodiments, I/O 309 may comprise a GPS chip set and/or the like for determining the position of the give computer.

In FIG. 3, in some embodiments, the outputs of I/O 309 may be one or more outputs selected from: information displayed on a monitor, screen (including a touchscreen), or display of the given computer; readouts; speakers; buzzers; bells; whistles; lights (LEDs) of the given computer; alarms; printers of and/or in communication with the given computer; outgoing information transmitted via the hardwired port (e.g., a USB port or the like) of the given computer; outgoing information transmitted via network communications module 307, and/or the like.

Continuing discussing FIG. 3, in some embodiments, processor 301 may execute a computer program known as an operating system (e.g., a Microsoft Windows operating system, a Linux operation system, an Apple and/or Macintosh operating system, a mobile computing device operating system, any other suitable operating system, and/or combinations thereof) which may control the execution of other computer programs (e.g., application programs, such as, but not limited to web browsers and/or “mobile apps”); and may provide for scheduling, input/output (I/O) and other device control, accounting, compilation, storage assignment, data management, memory management, communication; and/or dataflow control. Collectively, processor 301 and its operating system may define a computer platform for which the application programs and other computer program languages may be written in. In some embodiments, processor 301 may also execute one or more computer programs (e.g., applications programs) to implement various functions and/or methods of the present invention, that may be one main aspect of the present invention. These computer programs may be written in any type of computer program language, including, but not limited to, a procedural programming language, object-oriented programming language, macro language, and/or combinations thereof.

These computer programs, including the operating system, may be stored (e.g., non-transitorily stored) in memory 303. Memory 303 may store (hold) information on a volatile or non-volatile medium, and may be fixed and/or removable. Memory 303 may include a tangible computer readable and computer writable non-volatile recording medium, on which signals are stored that define a computer program or information to be used by the computer program. The recording medium may, for example, be disk memory, flash memory, and/or any other article(s) of manufacture usable to record and store information (in a non-transitory fashion). In some embodiments, in operation, processor 301 may cause(s) data and/or files (such as, but not limited to, the access-information, the one or more audio files, user-computing-device 201 model number, user-computing-device 201 serial number, user-computing-device 201 media address (MAC address), user-computing-device 201 IP address, user name, password, user account data, user profile data, user preference data, audio file usage logs, audio file access logs, camera captures, GPS/positional information, passcodes, etc.) to be read from the nonvolatile recording medium into a volatile memory (e.g., a random access memory, or RAM) that may allow for more efficient (i.e., faster) access to the information by the processor 301 as compared against the nonvolatile recording medium. Such RAM memory may be located in/on the memory 303 and/or in/on processor 301. The processor 301 may manipulate(s) the data within integrated circuit memory and may then copy the data to the nonvolatile recording medium after processing may be completed. A variety of mechanisms are known for managing data movement between the nonvolatile recording medium and the integrated circuit memory element, and the invention is not limited to any mechanism, whether now known or later developed. The invention is also not limited to a particular processing unit (e.g., processor 301) nor to a particular storage unit (e.g., memory 303).

Note, each and every method and/or step discussed herein and as depicted in the figures may be implemented as non-transitory computer-readable medium including codes executable by a processor, such as processor 301. That is, such non-transitory computer-readable medium may be the one or more memory 303 storage units. That is, such a processor may be processor 301; or alternatively, processor 301 may comprise such a processor.

The web browser software and/or mobile apps software (e.g., as types of computer programs) may be non-transitorily stored in memory 303. In some embodiments, the web browser software and/or the mobile apps software may be distributed across several and different memory 303s of a single computer. In some embodiments, the mobile apps software may be distributed across several and different memory 303s of several and different computers (e.g., several/different user-computing-devices 201 and/or several/different servers 203).

New and/or updates to code, programs, software applications, operating system, firmware, the web browser software and/or the mobile apps software may be saved non-transitorily onto memory 303 from I/O 309 and/or via network communications module 307.

Continuing discussing FIG. 3, in some embodiments, processor 301 may also be in communication with network communications module 307. Processor 301 may control network communications module 307, depending upon the instructions that processor 301 may be processing/executing. Network communications module 307 may permit communications between user-computing-device 201 and/or server 203 (see e.g., FIG. 2).

In some embodiments, network communications module 307 may comprise one or more radios and/or antennas to facilitate wireless communications, such as WiFi (Wi-Fi), Bluetooth, ZigBee, cellular, RFID, NFC, a predetermined wireless communication protocol, combinations thereof, and/or the like. In some embodiments, network communications module 307 may comprise at least one Bluetooth chipset and/or the like. In some embodiments, network communications module 307 may comprise a network card and/or a network adapter. In some embodiments, network communications module 307 may be a network card and/or a network adapter. In some embodiments, network communications module 307 may be in wired and/or wireless communications with the Internet, WAN (wide area network), LAN (local area network) (see e.g., internet/network/WAN/LAN 205 in FIG. 2). Communications between a given computer (such as user-computing-device 201 and/or the at least one server 203) that may rely upon network communications module 307 and one or more of another computer—may be routed through such a network (see e.g., internet/network/WAN/LAN 205 in FIG. 2). In some embodiments, network communications module 307 may comprise one or more radios and/or antennas to facilitate reading, interrogating, and/or scanning of RFID tags (and/or NFC tags); wherein “RFID” may refer to radio frequency identification and “NFC” may refer to near field communication.

In some embodiments, power-supply 311 may provide electrical power to the main sub-hardware elements and/or electronics of the given computer (such as user-computing-device 201 and/or the at least one server 203). In some embodiments, power-supply 311 may be one or more batteries. In some embodiments, power-supply 311 may be one or more rechargeable batteries. In some embodiments, power-supply 311 may be one or more backup batteries. In some embodiments, power-supply 311 may be one or more AC/DC adapters or electrical power conditioners allowing the given computer to receive standardized AC electrical power from a wired power source. In some embodiments, power-supply 311 may comprise one or more: batteries, rechargeable batteries, backup batteries, AC/DC adapters, capacitors, electromagnetic harvester circuits (e.g., for wireless charging/powering), combinations thereof, and/or the like.

At least some sub-hardware elements/components (as shown in FIG. 3 and as discussed above for FIG. 3) of a given computer, such as user-computing-device 201 and/or the at least one server 203, including their workings and configurations, are well known in the relevant computing and electronics industries and such information is incorporated herein by reference.

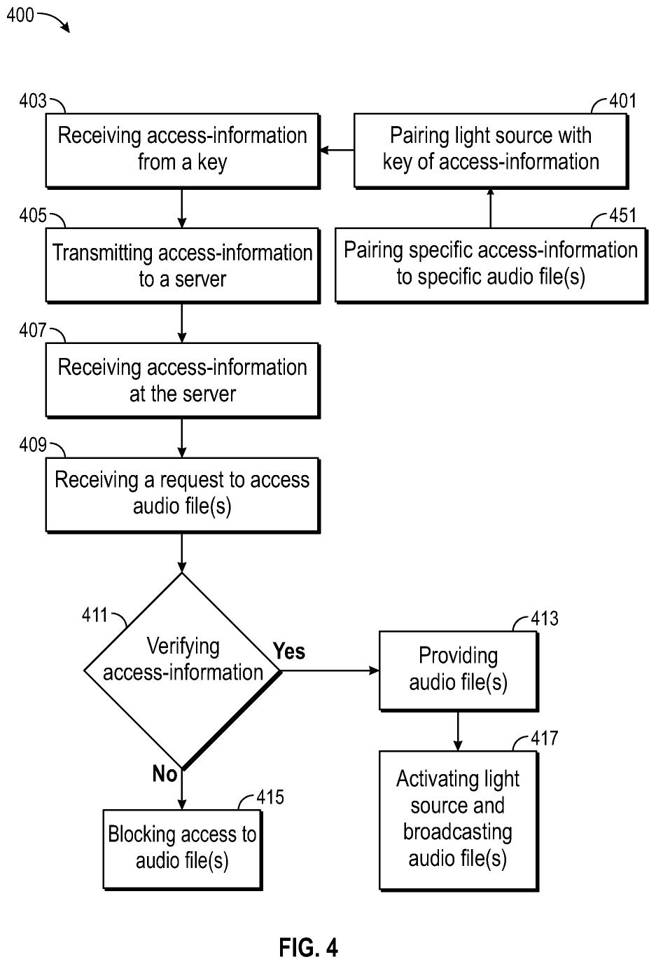

FIG. 4 may depict at least some steps in a method 400. In some embodiments, method 400 may be a method of providing guided meditation. In some embodiments, method 400 may comprise one or more of the following steps: 401, 403, 405, 407, 409, 411, 413, 415, 417, and 451. In some embodiments, at least some of these steps may be optional. In some embodiments, at least some of the steps may be performed out of numerical order with respect to the reference numeral assigned to the steps.

Discussing FIG. 3, in some embodiments, step 401 may be a step of pairing a given light source 100 with a given key 101/103/105/107. In some embodiments, this pairing may mean this given light source 100 and this given key 101/103/105/107 are intended to move together in the typical/planned stream of commerce. For example, and without limiting the scope of the present invention, this pairing may mean this given light source 100 and this given key 101/103/105/107 are sold together. In some embodiments, step 401 may progress to step 403.

Continuing discussing FIG. 4, in some embodiments, step 403 may be a step of receiving the access-information from the given key 101/103/105/107 at a given user-computing-device 201. In some embodiments, this receiving step may be accomplished by scanner 305 scanning, reading, interrogating, and/or communicating with the given key 101/103/105/107 to obtain the access-information coded to that given key 101/103/105/107. In some embodiments, this initial receiving of the access-information from at least one the keys that was paired to light source 100, may be received at a given user-computing-device 201 (such as, but not limited to, a smartphone or the like). In some embodiments, step 403 may progress to step 405.

Continuing discussing FIG. 4, in some embodiments, step 405 may be a step of transmitting (communicating) the access-information that was received at the given user-computing-device 201 in step 403, to the at least one server 203. Such transmitting may go over and/or through at least portion(s) of Internet/WAN/LAN 307 to arrive at the at least one server 203. In some embodiments, in addition to transmitting (communicating) the access-information in step 405, at least some of the “unique identifying characteristics” for that given user-computing-device 201 may also be transmitted from user-computing-device 201 to the at least one server 203 in step 405. In some embodiments, the at least some of the “unique identifying characteristics” for that given user-computing-device 201 may comprise one or more of: the model number, the serial number, the media address (MAC address), the IP address, combinations thereof, and/or the like with respect to that particular user-computing-device 201. In some embodiments, step 405 may progress to step 407.

Continuing discussing FIG. 4, in some embodiments, step 407 may be a step of receiving the access-information (from a given key 101/103/105/107 of a given light source 100) at the at least one server 203. In some embodiments, in addition to receiving this access-information, in step 407, the at least one server 203 may also receive the at least some of the “unique identifying characteristics” for that given user-computing-device 201. In some embodiments, step 407 may progress to step 409.

Continuing discussing FIG. 4, in some embodiments, step 409 may be a step of receiving a request to access/use the one or more audio files, wherein this request may be received at the at least one server 203. In some embodiments, this request may originate with the given user-computing-device 201 (such as, but not limited to, a smartphone or a smart speaker). In some embodiments, this request may be a request for the given user-computing-device 201 to access and/or use the one or more audio files on that given user-computing-device 201 (or on a client/slave device of that given user-computing-device 201). In some embodiments, in step 409, in addition to receiving this request to access/use the one or more audio files; the at least one server 203 may also receive the at least some of the “unique identifying characteristics” for that given user-computing-device 201. In some embodiments, step 409 may progress to step 411.

Continuing discussing FIG. 4, in some embodiments, step 411 may be a step of verifying/validating the access-information received by the at least one server 203 in step 407; and optionally and additionally, verifying information in the received request to access/use the one or more audio files from step 409. In some embodiments, this verification/validation step 411 may at least entail examining database lookup tables that may be non-transitorily stored in memory 303 of the at least one server 203; wherein these lookup tables may comprise pairings of the specific access-information with the specific/particular one or more audio files. In some embodiments, if this verification/validation step is successful, then step 411 may progress to step 413; whereas, if this verification/validation step is unsuccessful, then step 411 may progress to step 415.

Continuing discussing FIG. 4, in some embodiments, step 413 may be a step of providing the requested one or more audio files. In some embodiments, in step 413, the at least one server 203 may cause the one or more audio files to be provided for use and/or access on/by the given user-computing-device 201. In some embodiments, this step 413 of providing the requested one or more audio files from the at least one server 203 to the given user-computing-device 201, may be in the form of “streaming,” such that the one or more audio files themselves are not transferred from the at least one server 203 to the given user-computing-device 201, but rather only the content of the one or more audio files may be provided (played and/or broadcast). Streaming embodiments may require an active internet connection between the given user-computing-device 201 and the at least one server 203. Streaming embodiments may not require proprietary software on the given user-computing-device 201; rather, preexisting software on the given user-computing-device 201, such as, but not limited to, web browsers and/or media players software may be sufficient for such streaming embodiments. Whereas, in other embodiments, this providing of the one or more audio files from the at least one server 203 to the given user-computing-device 201 in step 413, may be in the form of transferring copies of the one or more audio files themselves from the at least one server 203 to the given user-computing-device 201, i.e., not streamed. In either scenario (streamed or actual file transfer), there may be limitations that stop access/use of the one or more audio files (on/at the given user-computing-device 201) after some triggering event. In some embodiments, this triggering event, may be a predetermined amount of elapsed time (e.g., 30 days or other time periods) from when the scanner 305 of the given user-computing-device 201 scanned, read, interrogated, and/or communicated the access-information from the given key 101/103/105/107. In some embodiments, this triggering event, may be a predetermined amount of streams or a predetermined amount of plays from transferred one or more audio files. In some embodiments, once this triggering event has occurred, user-computing-device 201 may be barred from using and/or accessing the one or more audio files. In some embodiments, step 413 may progress to step 417.

Continuing discussing FIG. 4, in some embodiments, step 417 may be a step of activating the given light source 100. In some embodiments, this may entail lighting a candle, if light source 100 is a candle. In some embodiments, this may entail turning on light source 100, if light source 100 is an electronic light source. In some embodiments, step 417 may be a step of broadcasting and/or playing the one or more audio files (e.g., from a speaker(s) and/or headphones of the given user-computing-device 201). In some embodiments, the played/broadcast one or more audio files may include instructions (e.g., verbal instructions) for a guided meditation session. In some embodiments, those instructions may include instructions to activate the given light source 100. In some embodiments, the played/broadcast one or more audio files may play/broadcast instructions, soundbaths, sounds, predetermined sounds, music, predetermined music, combinations thereof, and/or the like. In some embodiments, during step 417, both the light source 100 may be active (e.g., emitting light) and the one or more audio files may be emitted/broadcast from speakers/headphones associated with user-computing-device 201.

Continuing discussing FIG. 4, in some embodiments, step 415 may be a step of blocking access and/or use of the requested one or more audio files.

Continuing discussing FIG. 4, in some embodiments, step 451 may be a step of pairing specific access-information with specific one or more audio files in database table(s) that may be non-transitorily stored in memory 303 of the at least one server 203. In some embodiments, step 451 may be a step of pairing/linking a specific predetermined themed light source 100 with a specific predetermined soundbath that may be of the specific one or more audio files; and this may be accomplished by pairing/linking that specific predetermined themed light source 100 with a specific key 101/103/105/107 for the desired soundbath (desired one or more audio files). Having such database look up tables established may help to facilitate the verification/validation step of step 411. In some embodiments, step 451 may progress to step 401. In some embodiments, step 451 may occur prior to sale of a given light source 100 with its key 101/103/105/107.

In some embodiments, steps 401, 403, 405, 407, 409, 411, 413, 415, 417, and 451, may be facilitated by and/or accomplished by software running on at the least one server 203 and/or different software running on the given user-computing-device 201.

In some embodiments, the invention may be a system for facilitating and/or providing guided meditation. In some embodiments, this system may comprise at least one light source 100 and at least one key 101/103/105/107. In some embodiments, the system may further comprise the packaging 109. In some embodiments, the system may further comprise the access-information that may be coded to and/or embedded with the keys 101/103/105/107. In some embodiments, the one or more audio files may be one or more media files (or in the alternative, one or more media files may comprise the one or more audio files). In some embodiments, the system may further comprise the one or more audio files. In some embodiments, the system may further comprise the one or more media files. In some embodiments, the one or more media files (or the one or more audio files) may be selected from: an audio file, a music file, a sound file, a nature sound file, a file comprising verbal instructions when played, a soundbath file, a video file, combinations thereof, and/or the like. In some embodiments, the one or more media files (or the one or more audio files), when played, may comprise a curated guided meditation session.

In some embodiments, the at least one light source 100 may be at least one candle 100. In other embodiments, the at least one light source 100 may be an electrically operated light emitting device. In some embodiments, the at least one light source 100 may be configured to operate according to at least one predetermined theme. In some embodiments, the at least one predetermined theme is selected from one or more of: emission of a predetermined scent, emission of a predetermined fragrance, emission of light of a predetermined intensity, emission of light for a predetermined length of time, emission of light of a predetermined color, emission of light of a predetermined wavelength, combinations thereof, and/or the like.

In some embodiments, the at least one key 101/103/105/107 may be one or more of: a bar code, a quick response (QR) code, a two-dimensional code, a three-dimensional code, a radio frequency identification (RFID) tag, a near field communication (NFC) tag, combinations thereof, and/or the like. In some embodiments, the at least one key 101/103/105/107 may be physically attached to the at least light source 100. In some embodiments, the at least one key 101/103/105/107 may be located: (1) on an exterior surface of the at least one light source 100; (2) embedded within the at least one light source 100; (3) partially within the at least one light source 100 and partially outside of the at least one light source 100; or (4) not physically attached to the at least one light source 100.

In some embodiments, the at least one light source 100 and the at least one key 101/103/105/107 may be associated with each other, at least prior to use by the user. In some embodiments, the at least one light source 100 and the at least one key 101/103/105/107 being associated with each other, may at least comprise that the at least one light source 100 and the at least one key 101/103/105/107 being packaged together.

In some embodiments, the system may further comprise the packaging 109; wherein the at least one light source 100 may reside at least partially within the packaging 109 prior to the at least one light source 100 being used by the user; wherein the at least one key 101/103/105/107 may be associated with the packaging 109. In some embodiments, the at least one key 101/103/105/107 may be located: (1) on an exterior surface of packaging 109; (2) embedded within the packaging 109; or (3) partially within the packaging 109 and partially outside of the packaging 109; or (4) inside of the packaging 109.

In some embodiments, the system may further comprise the at least one server 203.

In some embodiments, the system may further comprise memory 303 of the at least one server 203.

In some embodiments, the system may further comprise at least one database, wherein that at least one database may be non-transitorily stored within memory 303 of the at least one server 203. In some embodiments, the access-information may be paired to the one or more media files (the one or more audio files) in a table of the at least one database.

In some embodiments, the system may further comprise the software non-transitorily stored in memory 303 of the least one server 203. In some embodiments, the system may further comprise proprietary software (proprietary mobile app) non-transitorily stored in memory 303 of user-computing-devices 201.

In some embodiments, the one or more audio files may be one or more media files. In some embodiments, the one or more media files may comprise visual and/or graphic components, such as, but not limited to video (video files).

In some embodiments, packaging 109, light source 100, and/or key(s) 101/103/105/107 may be one or more of: made substantially from recycled materials, may be recycled, substantially made from environmentally friendling/renewable resources, combinations thereof and/or the like.

Systems and methods of facilitating and/or providing guided meditation have been described. The foregoing description of the various embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A system for guided meditation, wherein the system comprises:
at least one light source;
at least one key, wherein the at least one key comprises access-information, wherein the access information are means for providing access to one or more media files by a computing device of a user;
wherein the at least one light source and the at least one key are associated with each other.

2. The system according to claim 1, wherein the at least one light source is at least one candle.

3. The system according to claim 1, wherein the at least one light source is configured to operate according to at least one predetermined theme.

4. The system according to claim 3, wherein the at least one predetermined theme is selected from one or more of: emission of a predetermined scent, emission of a predetermined fragrance, emission of light of a predetermined intensity, emission of light for a predetermined length of time, emission of light of a predetermined color, or emission of light of a predetermined wavelength.

5. The system according to claim 1, wherein the at least one key is one or more of: a bar code, a quick response (QR) code, a two-dimensional code, a three-dimensional code, a radio frequency identification (RFID) tag, or a near field communication (NFC) tag.

6. The system according to claim 1, wherein the at least one key is physically attached to the at least light source.

7. The system according to claim 1, wherein the at least one key is located: (1) on an exterior surface of the at least one light source; (2) embedded within the at least one light source; or (3) partially within the at least one light source and partially outside of the at least one light source.

8. The system according to claim 1, wherein the at least one light source and the at least one key being associated with each other comprises that the at least one light source and the at least one key are packaged together.

9. The system according to claim 1, wherein the system further comprises at least one database, wherein the access-information is paired to the one or more media files in a table of the at least one database.

10. The system according to claim 1, wherein the system further comprises the one or more media files.

11. The system according to claim 1, wherein the one or more media files are selected from: an audio file, a music file, a sound file, a nature sound file, a file comprising verbal instructions when played, a soundbath file, a video file, or combinations thereof.

12. The system according to claim 1, wherein the one or more media files, when played, comprises a curated guided meditation session.

13. The system according to claim 1, wherein the system further comprises packaging, wherein the at least one light source resides at least partially within the packaging prior to the at least one light source being used by the user; wherein the at least one key is associated with the packaging.

14. The system according to claim 13, wherein the at least one key is located: (1) on an exterior surface of packaging; (2) embedded within the packaging; or (3) partially within the packaging and partially outside of the packaging.

15. A method for guided meditation, wherein the method comprises steps of:
(a) pairing a light source with a key, wherein the key comprises access-information, wherein the access information are means for providing access to one or more media files by a computing device of a user;
(b) receiving the access-information, wherein the access-information is received at at least one server;
(c) receiving a request to access the one or more media files, wherein this request is received at the at least one server;
(d) verifying the access-information received at the at least one server;
(e) if the access-information is verified, then providing the one or more media files to the computing device of the user; and
(f) if the access-information is not verified, then not providing the one or more media files to the computing device of the user.

16. The method according to claim 15, wherein prior to the step (a), the method comprises a step of pairing the access-information to the one or more media files.

17. The method according to claim 15, wherein prior to the step (b), the method comprises a step of receiving the access-information at the computing device of the user.

18. The method according to claim 15, wherein prior to the step (b), the method comprises a step of transmitting the access-information from the computing device of the user to the at least one server.

19. The method according to claim 15, wherein after the step (e), the method comprises a step of broadcasting the one or more media files.

20. The method according to claim 15, wherein after the step (e), the method comprises a step of broadcasting the one or more media files and activating the light source.
